(19) United States
(12) Patent Application Publication
(10) Pub. No.: US 2012/0173970 A1
(43) Pub. Date: Jul. 5, 2012

(54) Automatic Translation of Visual Information Between a Handheld Calculator and a Computer System

(76) Inventor: Daniel Richard Gremillion, Fairview, TX (US)

(21) Appl. No.: 13/342,906

(22) Filed: Jan. 3, 2012

Related U.S. Application Data
(60) Provisional application No. 61/429,475, filed on Jan. 4, 2011.

(51) Int. Cl. G06F 17/00

(52) U.S. Cl. 715/246; 715/253

(57) ABSTRACT

Methods for generating a publication view of a handheld calculator document is provided. One method includes assigning a first page of a document to a first cell of a sheet in a publication view, wherein the sheet is logically divided into a plurality of cells arranged in a grid, and wherein the first page includes at least one application executable on a handheld calculator, formatting the first cell responsive to user-specified format changes, and saving the publication view of the document, wherein formatting information for the first cell is saved in association with the document. Another method includes opening a document in a publication view, wherein pages of the document are automatically assigned to cells in a grid in a sheet, formatting cells responsive to user-specified format changes, and saving the publication view of the document, wherein formatting information for the cells is saved in association with the document.

### CROSS-REFERENCE TO RELATED APPLICATIONS

This application claims benefit of U.S. Provisional Patent Application Ser. No. 61/429,475, filed Jan. 4, 2011, which is incorporated herein by reference in its entirety.

### BACKGROUND OF THE INVENTION

1. Field of the Invention

Embodiments of the present invention generally relate to automatic translation of visual information between a handheld calculator and a computer system.

2. Description of the Related Art

With ever increasing frequency, handheld calculators connected to a classroom network and/or software on computer systems emulating the functionality of the handheld calculators are used for instruction and testing. Using either a handheld calculator or teacher calculator emulation software on a computer system, a teacher may generate lessons and examinations that may be distributed to student handheld calculators or student calculator emulation software. Students may complete the problems in the lessons or the examinations using a handheld calculator or the emulation software. In general, the content of the lessons and examinations and the student results is limited to the display and software capabilities of a handheld calculator.

### SUMMARY

Embodiments of the present invention relate to methods and systems for generating a publication view of a calculator document. In one aspect, a method includes assigning a first page of a document to a first cell of a sheet in a publication view, wherein the sheet is logically divided into a plurality of cells arranged in a grid and wherein the first page includes at least one application executable on a handheld calculator, formatting the first cell responsive to user-specified format changes, and saving the publication view of the document, wherein formatting information for the first cell is saved in association with the document.

In one aspect, a method includes assigning a first application to a first cell of a sheet in a publication view of an empty document, wherein the sheet is logically divided into a plurality of cells arranged in a grid and wherein the first application is executable on a handheld calculator and wherein a page of the document comprising the first application is created responsive to the assigning, formatting the first cell responsive to user-specified format changes, and saving the publication view of the document, wherein formatting information for the first cell is saved in association with the document.

In one aspect, a method includes opening a document in a publication view, wherein pages of the document are automatically assigned to cells in a grid in a sheet according to a page assignment order, wherein each page includes at least one application executable on a handheld calculator, formatting at least a subset of the cells responsive to user-specified format changes, and saving the publication view of the document, wherein formatting information for the subset of cells is saved in association with the document.

### BRIEF DESCRIPTION OF THE DRAWINGS

Particular embodiments in accordance with the invention will now be described, by way of example, and with reference to the accompanying drawings:

FIGS. 1A-1C show a system diagram illustrating data flow between a handheld calculator and a computer system;

FIGS. 2A-2C show an example of a document;

FIG. 3 shows an example user interface screen;

FIGS. 4A and 4B show an example initial publication view of the document of FIGS. 2A-2C;

FIGS. 5A and 5B show an example formatted publication view of the document of FIGS. 2A-2C;

FIGS. 6A-6C show an example of clipping of a document page in a cell and resizing the cell after clipping;

FIGS. 7A and 7B show example printable views of the publication view of FIGS. 5A and 5B;

FIGS. 8 and 9 are flow diagrams of methods; and

FIGS. 10-13 are diagrams of systems.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Users of handheld calculators and calculator emulation software in instructional environments would like to view the same information on both handheld calculators and computer systems (e.g., desktop computers, laptops, tablet devices, etc.) in ways that maximize the effectiveness of the information conveyed according to the relative capabilities of the platform. More specifically, users want to create information on a handheld graphing calculator (or using calculator emulation software) and reformat that information on a computer system into a view with a layout that provides better readability and comprehension.

Embodiments of the invention provide for formatting of a document created on a handheld calculator (or using calculator emulation software) to generate a publication view of the document. The formatting is performed using a grid-based editing approach in which the sequential pages of the document may be automatically or manually mapped to sheets in the publication view. More specifically, the initial publication view of the document includes one or more sheets of document pages, depending factors such as the number of pages in the document, the size of a sheet, etc. Each sheet is logically divided into a grid of cells and document pages may be automatically assigned to grid cells and sheets according to an assignment order or may be manually assigned to grid cells and sheets.

A user may format the publication view of a document to create the desired appearance and enhance the content. For example, in some embodiments, the user may resize the cells, move document pages from one cell/sheet to another, add or delete document pages, hide document pages, alter the content of document pages, crop document pages, etc. The user may also add publication objects to the publication view such as video, text boxes, images, hyperlinks, headers, footers, etc. Depending on the type of the publication object, a publication object may be assigned to a cell or may be layered on top of the grid. In general, publication objects may not be supported in a handheld calculator view of the document.

In some embodiments, a document may be initially created in publication view on a computer system. That is, a user may use the grid based editing approach to generate a handheld calculator document with publication view formatting.

In some embodiments, both a publication view of a document and a handheld calculator view of the document are maintained together such that any changes made to the document in calculator view will be reflected when the document is accessed in publication view and vice versa. That is, when the document is displayed on a handheld calculator (or in calculator emulation software), the document pages are displayed in the appropriate sequential order and when the document is displayed in publication view on a computer system, the document pages are displayed with the publication view formatting. In some such embodiments, publication objects are not included in the handheld calculator view. In some embodiments, publication objects may be converted to images in the handheld calculator view.

In some embodiments, association between the publication view and handheld calculator view of a document is not maintained. Rather, once a document is formatted in publication view, any changes made to the document content in the publication view are not reflected in the original document. Rather, to communicate the changes to a handheld calculator, the publication view is converted to a new document that includes the document pages in the publication view. This new document may then be communicated to a handheld calculator.

For illustrative purposes, embodiments of the invention may be described herein with reference to the TI-Nspire™ handheld graphing calculator and the TI-Nspire™ software available from Texas Instruments. One of ordinary skill in the art will appreciate that embodiments of the invention are not limited to the TI-Nspire™ calculator and TI-Nspire™ software.

A handheld calculator such as the TI-Nspire™ is capable of generating and operating on one or more documents. In the TI-Nspire™ environment, a document may include one or multiple problems. Each problem may contain multiple pages. Further, each page may be divided into multiple work areas and each work area may contain any of the TI-Nspire™ applications, e.g., Calculator, Graph, Geometry, Lists & Spreadsheet, Data & Statistics, and Notes. In general, a document is constructed and displayed as a sequential set of pages. Further, the ordering of the pages may reflect both logical and computational dependency between applications on different pages. That is, the pages may be ordered for logical presentation of the information in the pages. Further, computational dependency may be present through the use of variables. Variables may be shared among two or more applications in a problem and the applications may be on different pages. More specifically, and functions created or defined as variables in one application can be used in other applications within the same problem to share data. If a variable value is changed in the original application, the change is reflected in all other applications using the variable. The generation and use of documents for software version 3.0 is described in “TI-nspire™ Getting Started with the TI-Nspire™ Handheld”, Texas Instruments Incorporated, 2006-2011, which is incorporated by reference herein.

The TI-Nspire™ software executes on a computer system and enables users to perform the same functions on a computer system that can be performed on a TI-Nspire™ calculator, i.e., the software emulates the calculator operation. Documents generated using the TI-Nspire™ software can be used on a TI-Nspire™ calculator and vice versa. Student and teacher versions of the TI-Nspire™ software are described in “TI-nspire™ Student Software Guidebook”, Texas Instruments Incorporated, 2006-2011, and “TI-nspire™ Teacher Software Guidebook”, Texas Instruments Incorporated, 2006-2011, which are incorporated by reference herein.

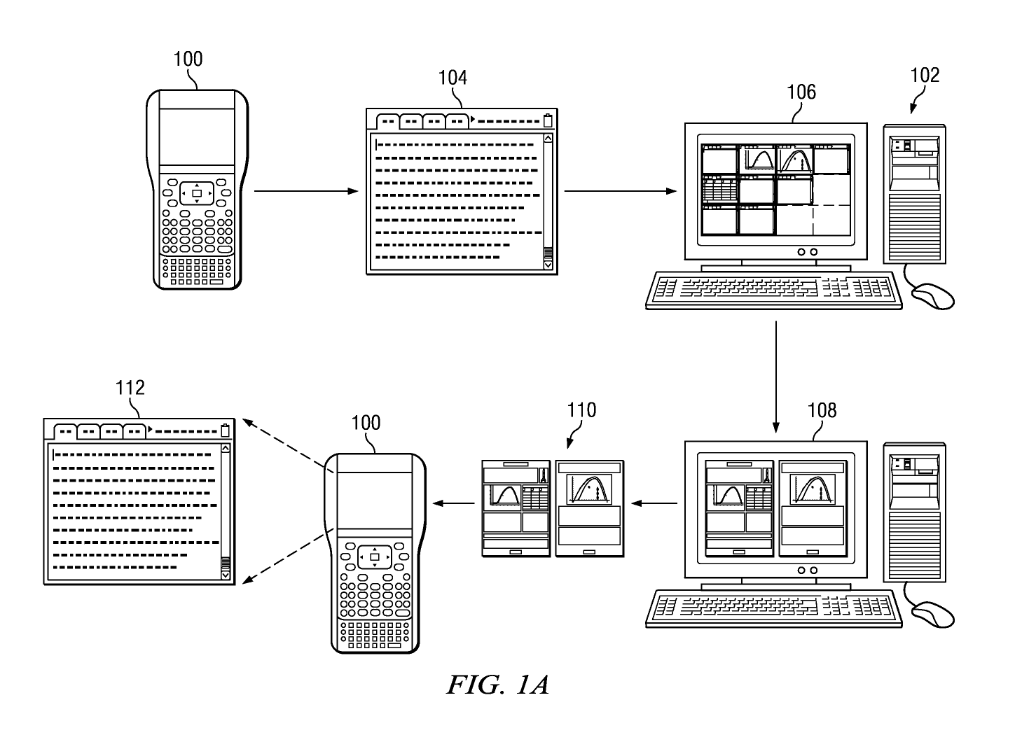

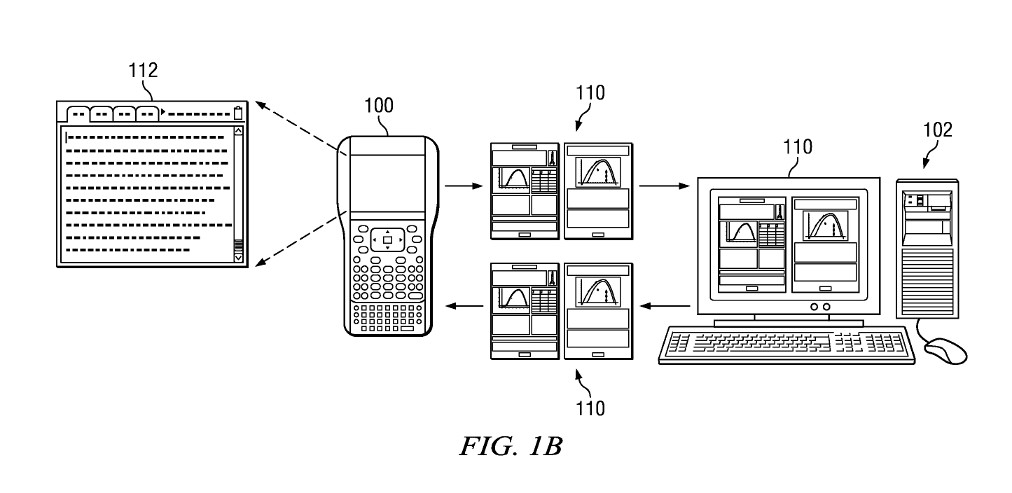

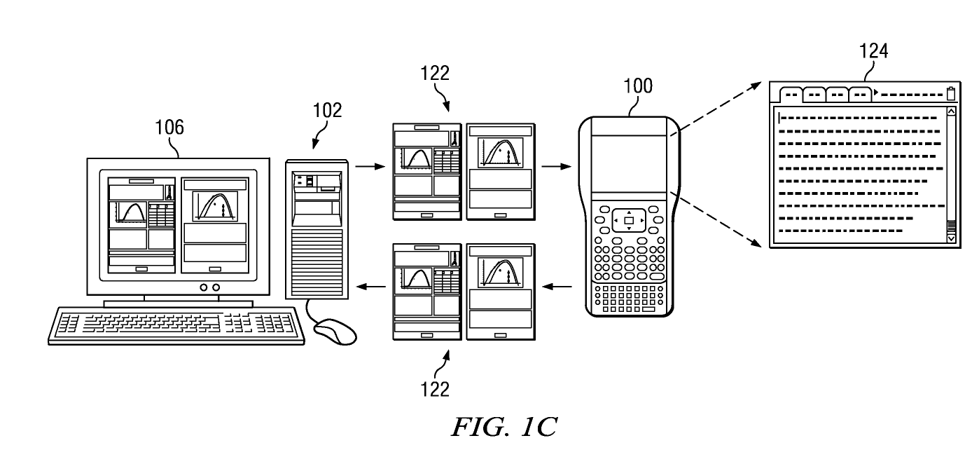

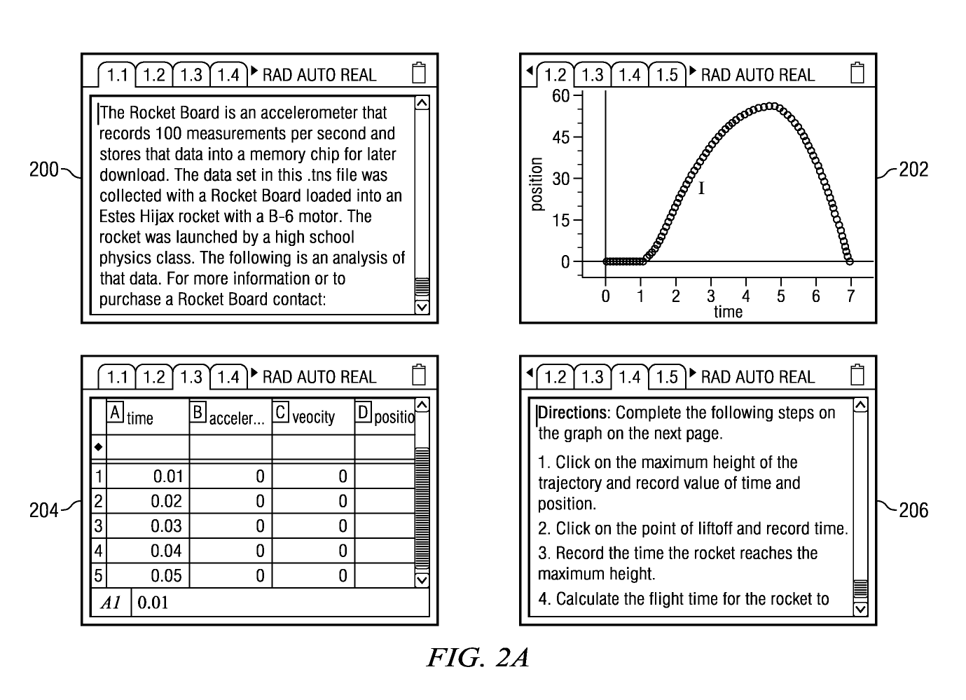

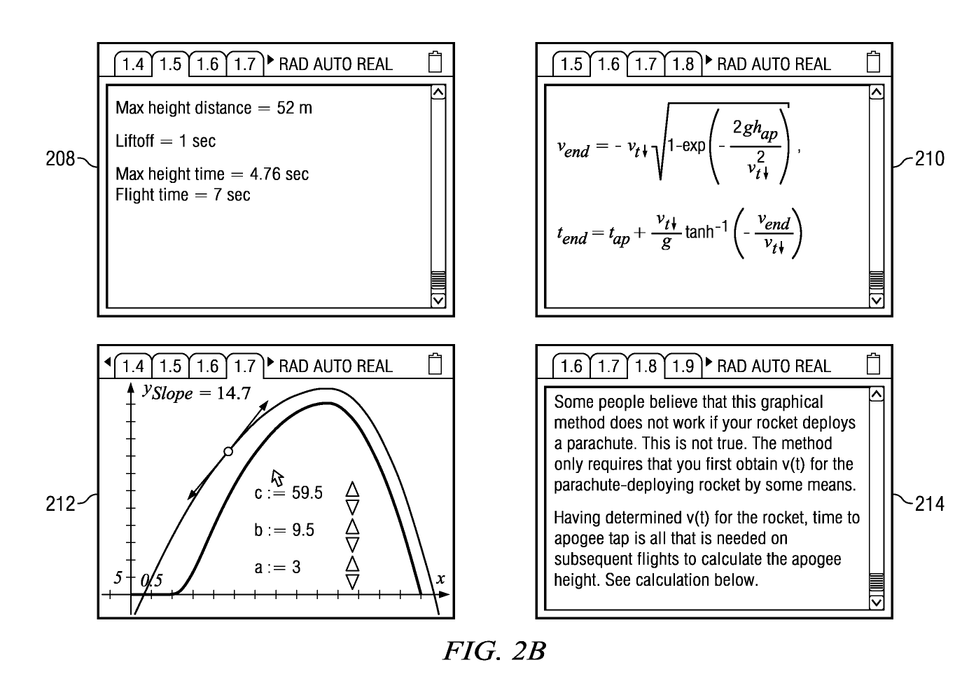

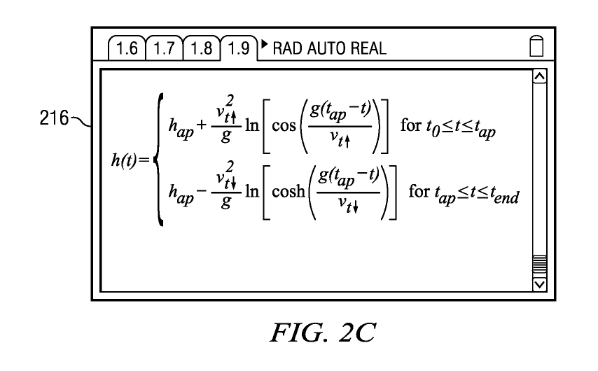

Embodiments will now be explained in reference to FIGS. 1A-1C and the examples of FIGS. 2A-7B. FIGS. 1A-1C show an example system diagram illustrating data flow between a handheld calculator and a computer system executing calculator emulation software. In the depicted system, a handheld graphing calculator 100 is communicatively coupled to a computer system 102 to provide for transfer of data between the calculator 100 and the computer system 102. The computer system 102 may be, for example, a desktop computer, a laptop computer, a notebook computer, a tablet computing device, or the like. The coupling between the calculator 100 and the computer system 102 may be wired, e.g., a universal serial bus (USB) connection, or wireless. Calculator emulation software incorporating functionality to format a handheld calculator document to generate a publication view of the document executes on the computer system 102.

As shown in FIG. 1A, a document 104 may be generated on the handheld calculator 100 and transferred to the computer system 102. FIGS. 2A-2C show the content of the document 104. As shown in FIGS. 2A-2C, the document 104 includes a single problem related to rocket trajectory. The problem includes nine pages that are ordered sequentially as shown in the tabs at the top of each page. On the handheld calculator 100, one page at a time may be displayed. The first page 200 contains a notes application containing text, the second page 202 contains a graph application, the third page 204 contains a spreadsheet application, the fourth page 206 contains another notes application, the fifth page 208 contains a notes application, the sixth page 210 contains a calculator application, the seventh page 212 contains another graph application, the eighth page 214 contains another notes application, and the ninth page 216 contains another calculator application.

The original document 104 is opened in a publication view mode 106 in the calculator emulation software executing on the computer system 102. In this example, a publication view of a document is made up of sheets the size of a printed page. Other sheet sizes may be used. When a sheet is initially added to the publication view, the sheet is logically divided into a grid of equal-sized cells. For example purposes, this grid is assumed to be two columns and three rows. Other grid configurations may be used. A cell in a grid may hold a document page or a publication object. As described in more detail herein, cells may be resized and the contents may be formatted or otherwise edited.

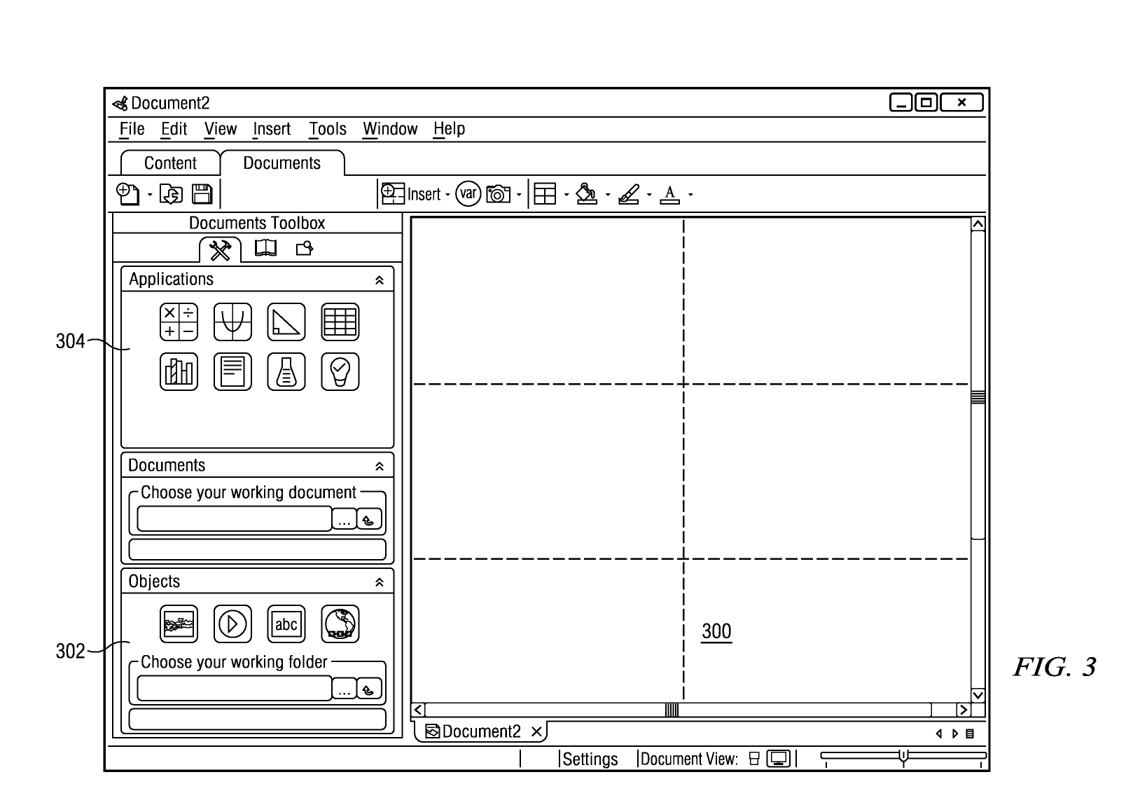

FIG. 3 shows an example user interface for publication view mode. The publication view pane 300 shows the publication view of the currently open document. When a document has not yet been opened in publication view, the publication view pane 300 shows a blank sheet that is divided into a grid of cells. In some embodiments, when the document 104 is opened in publication view mode, the pages of the document are automatically assigned to cells in one or more sheets. The order in which the pages are assigned to cells may be user configurable. In some embodiments, the pages are assigned in a left to right top down order according the sequential order of the pages in the document. In some embodiments, the user may manually assign each page of the document to a cell in a sheet.

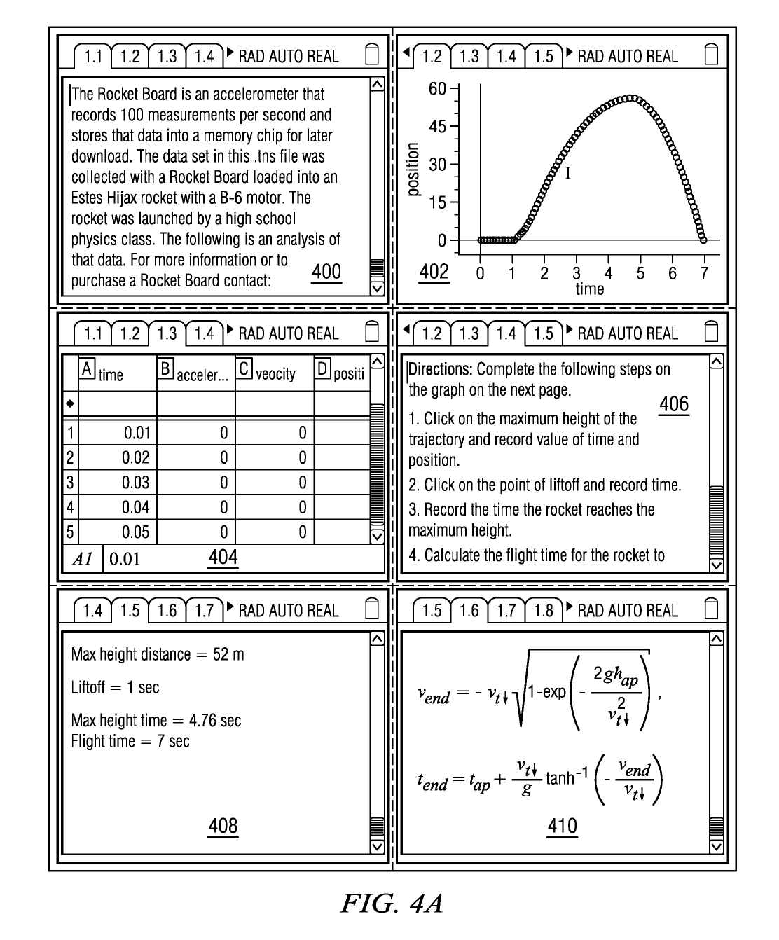

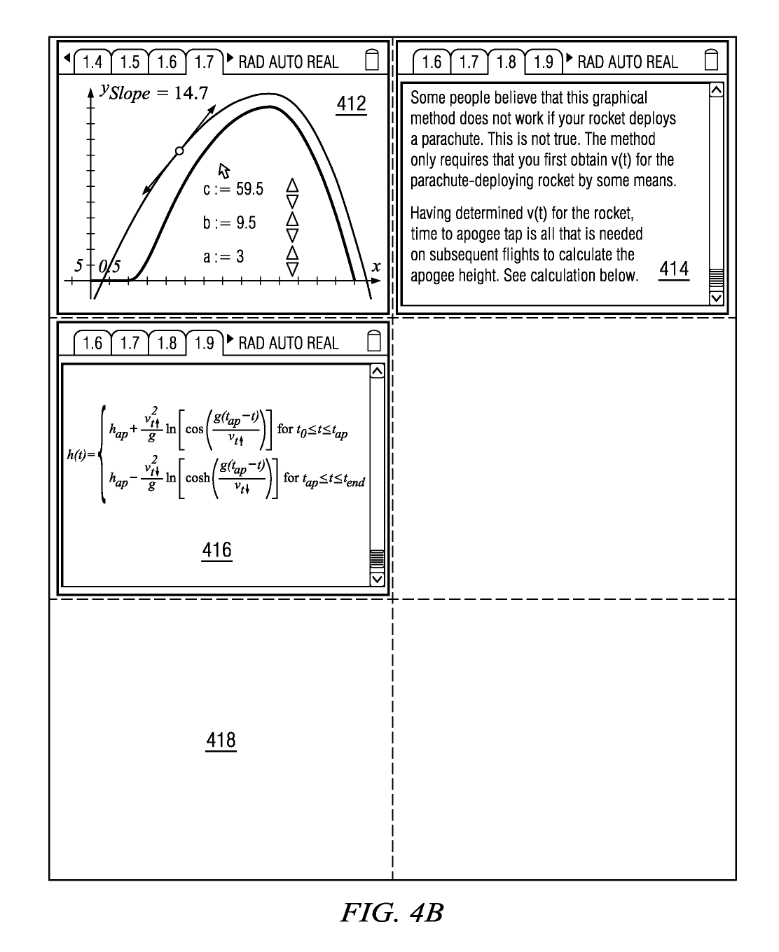

FIGS. 4A and 4B show the automatic assignment of the pages of the document 104 to sheets in the publication view. As there are nine pages in the document 104, two sheets are generated in the publication view. The first six pages are allocated in the logical grid of a first sheet (FIG. 4A) and remaining three pages are allocated in the grid of a second sheet (FIG. 4B). More specifically, page 200 is assigned to cell 400 of the first sheet, page 202 is assigned to cell 402, page 204 is assigned to cell 404, page 206 is assigned to cell 406, page 408 is assigned to cell 408, and page 210 is assigned to cell 410. Further, page 212 is assigned to cell 412 of the second sheet, page 214 is assigned to cell 414, and page 216 is assigned to cell 416. The applications in these pages are fully functional and operate as they would operate on the handheld calculator 100. In some embodiments, the page identifiers at the top of each page are not be shown when the pages are allocated to cells and sheets.

The user may now perform formatting operations to generate the desired publication view 108 of the document 104. The formatting operations may include, for example, resizing cells, adding rows and columns to a grid, moving document pages from one cell to another, moving document pages from one sheet to another, adding publication objects either in cells or layered on top of the grid, formatting the text in cells, adding or deleting pages, clipping pages, and/or hiding pages. Any suitable interface may be used to allow a user to perform the formatting operations. Some examples of suitable interfaces for formatting operations are described in the previously referenced TI-Nspire™ software guidebooks.

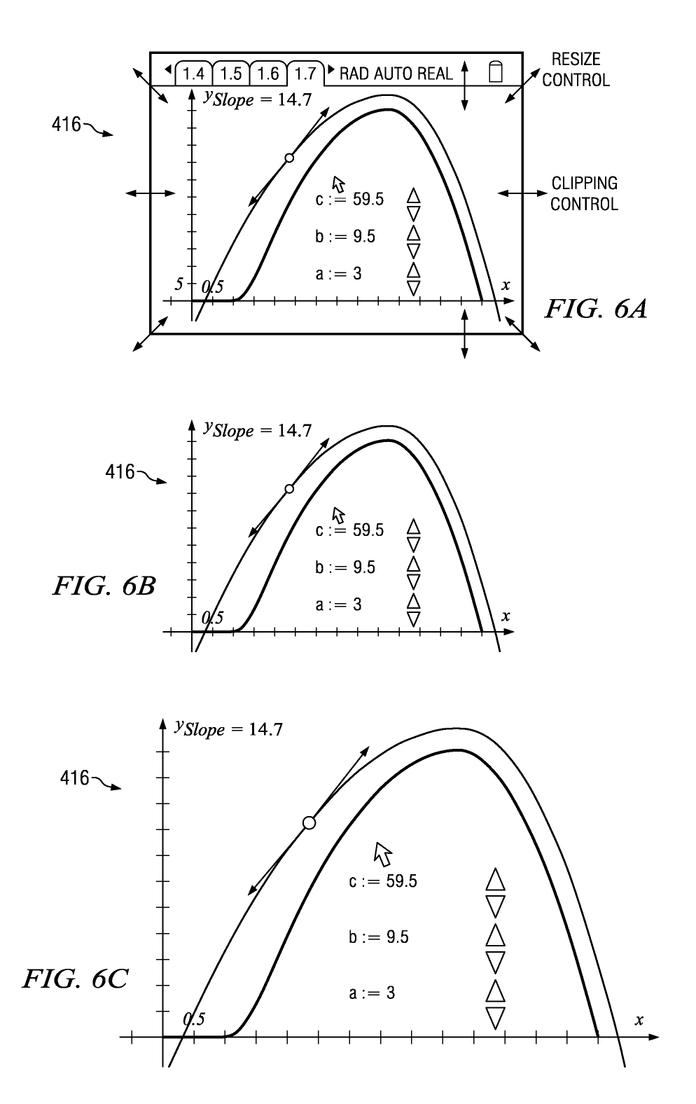

When a cell is resized, the cells above, below, and adjacent to that cell, if any, may also be resized to accommodate the change in size of the cell. For example, if the size of a cell is increased horizontally, the sizes of other cells in the same row are decreased to accommodate the increased horizontal size. Similarly, if the size of a cell is increased vertically in a downward direction, the sizes of other cells in the same row are also correspondingly increased vertically and the sizes of cells in rows below are proportionally decreased. When a cell is resized, the content of the cell is resized as appropriate. For example, an image in a cell may be proportionally resized. In another example, more or less of the content of document page may be shown in the cell if the cell size is increased or decreased. In another example, if a page is clipped in a cell, the clipped portion of the page is proportionally increased or decreased in size as the cell size is increased or decreased. Clipping is described in more detail in reference to FIG. 6.

Documents may contain pages that a user may not want to show in a publication view. For example, a document may contain one or more pages of data used by applications in other pages. As was previously mentioned, a user may elect to hide a page in a cell. When a page is hidden, the content of the cell containing that page is not shown in the publication view. In some embodiments, an icon or other indicator may be displayed in the publication view pane 300 to indicate the relative locations of hidden pages.

Publication objects may include, for example, text boxes, video, images, and hyperlinks. A text box is an object that allows the user to place additional text in the publication view. The text box object may provide text editing capabilities such as, for example, font selection, bold, underline, italics, word wrap, etc. A video object allows the user to add video with controls (e.g., start, stop, rewind, fast forward) to a cell in the publication view. An image object allows the user to place an image in a cell, and a hyper link object allows the use to add hyperlinks to the publication view. The publication objects may be added in any suitable way. For example, as shown in the example interface of FIG. 3, the available publication objects 302 are displayed as icons in a pane next to the publication view pane 300. The user may select, drag, and drop an icon to add a publication object to a sheet in the publication view. In another example, a user may right click in an empty cell to cause a popup menu with a list of publication objects to be displayed and select an object from the menu to be placed in the cell. Text boxes may be layered on top of a grid in a sheet to add such things as titles, headers, footers, callouts, etc.

Additional document pages may be added to the publication view in any suitable way. For example, as shown in the example interface of FIG. 3, the available calculator applications 304 are displayed as icons in a pane next to the publication view pane 300. The user may select, drag, and drop an icon to add an application to a cell in a sheet in the publication view. If the application is added to an empty cell, a new document page is created. In another example, a user may right click in an empty cell to cause a popup menu with a list of applications to be displayed and select an application from the menu to be placed in the cell.

If document pages are added or deleted, the sequential computational ordering of the pages is adjusted accordingly. However, if pages are moved from cell to cell, the sequential computation ordering of the pages is not changed. In other words, the sequential computational order of the document pages is maintained as the document is formatted in publication view unless the user explicitly elects to change the ordering.

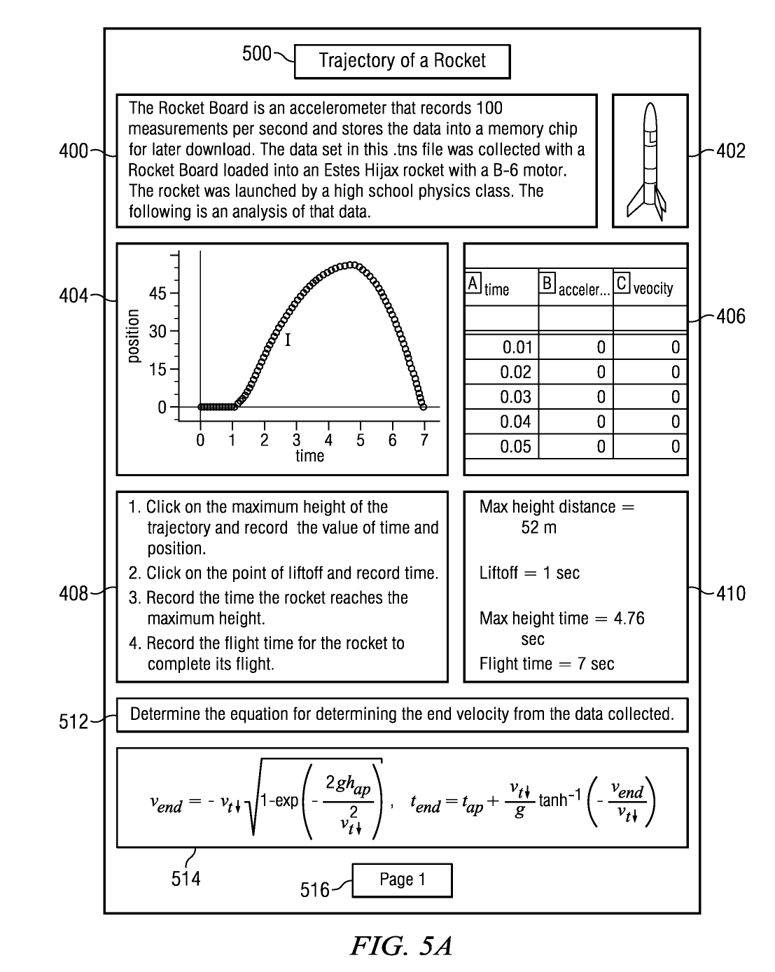

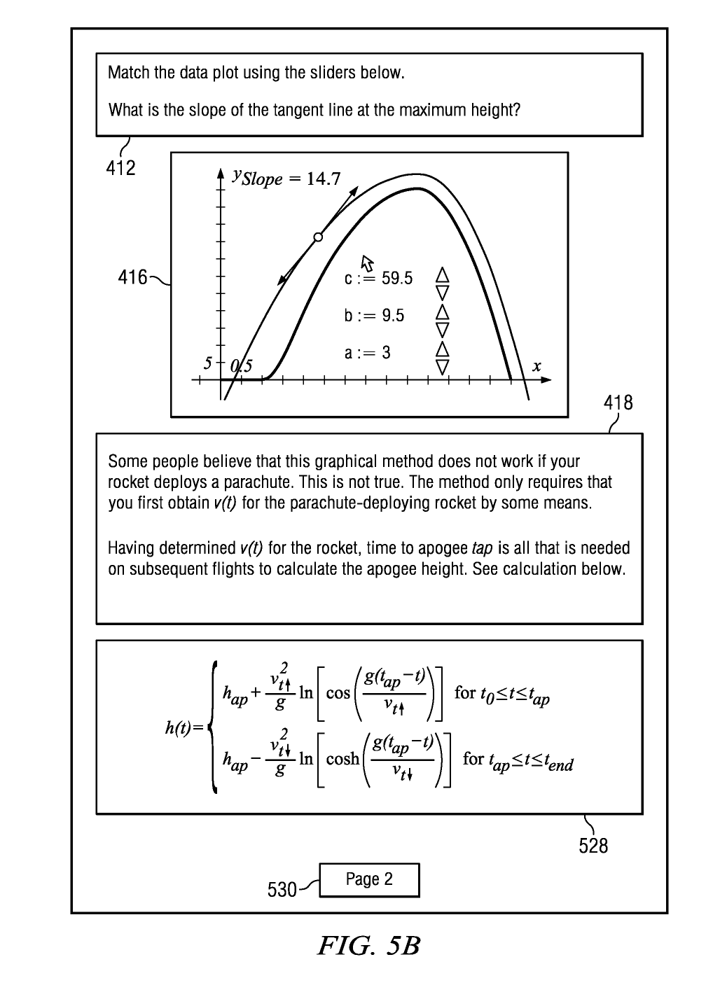

FIGS. 5A and 5B show an example formatted publication view 108 of the document 104 as generated by formatting the sheets of FIGS. 4A and 4B. In the sheet of FIG. 5A, page 202 that was formerly in cell 402 has been moved to cell 404, page 204 has been moved to cell 406, page 206 has been moved to cell 408, and page 208 has been moved to cell 410. Further, page 210, formerly in cell 410, has been moved to cell 514 in a grid row added to the sheet. Such movement may be accomplished, for example, by selecting the interior of a cell containing a page and dragging the page to another cell. Other suitable techniques may used to move pages from one cell to another. An image publication object has been placed in cell 402 and a text box publication object has been placed in a cell 512 of a grid row added to the sheet. Cells have also been resized to better present the content of the cells. Note that cells 512 and 514 have been resized to occupy an entire row in the grid, while cells in other rows have been proportionally resized within their respective rows. In addition, text box publication objects 500 and 516 have been layered on top of the grid to add a title and a page number to the sheet.

In the sheet of FIG. 5B, page 212 has been moved from cell 412 to cell 416, page 214 has been moved from cell 414 to cell 418, and page 216 has been moved from cell 416 to cell 528 in a grid row added to the sheet. A text box publication object has been placed in cell 412. Cells have also been resized to better present the content of the cells. In addition, a text box publication object 530 has been layered on top of the grid to add a page number to the sheet.

The document pages in the sheets of FIGS. 5A and 5B have been clipped to constrain the portion of each page that is shown in a cell. In general, clipping allows a user to select an area of a document page that is to be displayed in a cell. Once a page is clipped, when the size of the cell is changed, the size of the clipped content is changed proportional to the cell size change. For example, if the clipped area is a graph, then the size of the graph shrinks when the cell size is decreased and the size of the graph grows when the cell size is increased. Note that in this example all of the pages have been clipped such that the page number tabs are not shown and scroll bars are not shown.

FIGS. 6A-6C show an example of clipping and resizing of a cell containing a page with a graph application, i.e., page 212. FIG. 6A shows the cell 416 containing page 212 with clipping and resizing controls activated. As shown in FIG. 6A, the clipping controls have been used to designate the portion of the page to be displayed in cell 416. In this example, the page is clipped to show just the graph. The cell 416 with the clipped page is shown in FIG. 6B. FIG. 6C shows an example of increasing the size of the cell 416 in which the clipped area of the page, i.e., the graph, is increased in size rather than showing more of the page content.

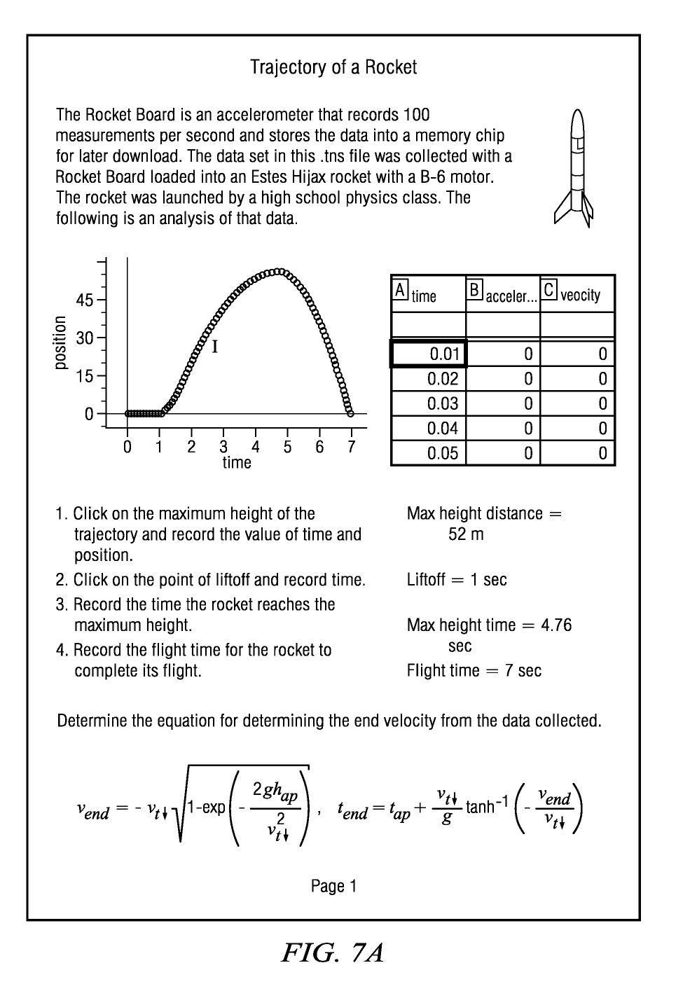

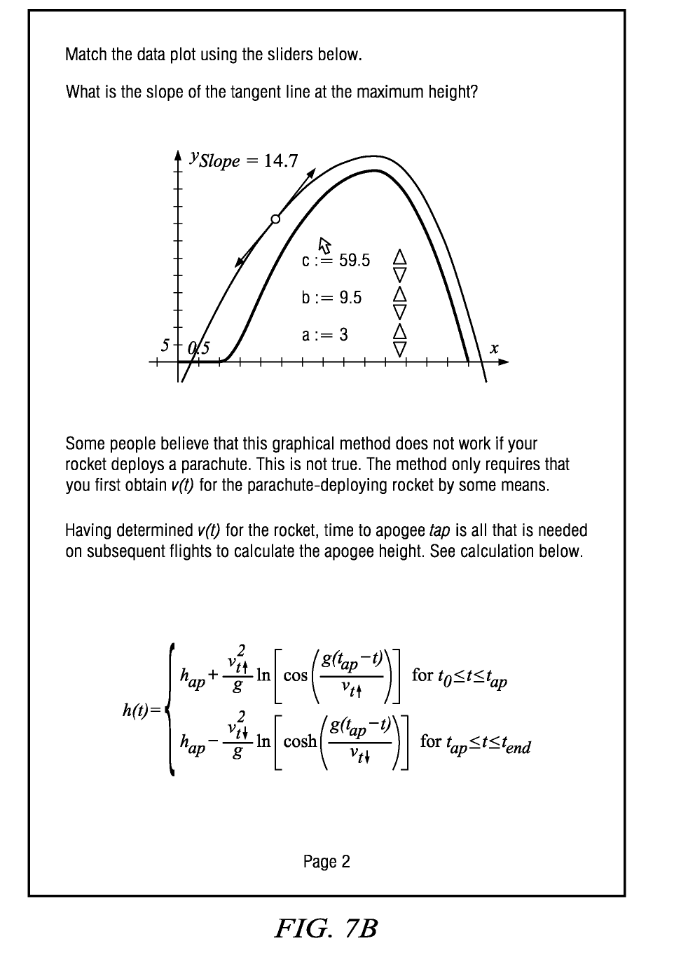

In some embodiments, as shown in FIGS. 4A, 4B, 5A, and 5B, a border is displayed around cells with content to allow the user to easily distinguish the different cells and overlaid publication objects. A printable view of the publication layout may be created by turning off the borders. FIGS. 7A and 7B show the printable views of the sheets of FIGS. 5A and 5B.

Referring again to FIG. 1A, once the publication view 108 is created, the formatting information for generating the publication view may be stored. The formatting information may be, for example, format rules for recreating the publication view of the document. There may be format rules for each sheet and each cell in a sheet specifying the size, content, locations, etc. of each cell and the size, content, location, etc. of any publication objects layered on a sheet. As shown in FIG. 1A, in some embodiments, the publication view formatting information and the calculator document pages may be maintained as a single logical metadocument 110, e.g., a file or set of files containing calculator document pages and formatting metadata, which may be transmitted back to the handheld calculator 100. On the handheld calculator 100, any format rules for the publication view are ignored and the document pages 112 may be displayed in sequential computational order. Any changes made to the original document 104 when the document was formatted in publication view such as adding or deleting pages or changing the content of pages are reflected in the document pages 112.

Further, as shown in FIG. 1B, once the metadocument 110 is created, changes to the metadocument 110 may be made on either the handheld calculator 100 or the computer system 102 according to the respective capabilities of the calculator 100 and the calculator emulation software on the computer system 102. The changed metadocument 110 may then be communicated from the system making the change to the other system.

Referring now to FIG. 1C, in some embodiments, a calculator document may be generated and formatted on the computer system 102 using publication view mode 106 in the calculator emulation software. That is, rather than opening an existing document in the publication view mode, a user may start with a blank sheet divided into a grid of cells. FIG. 3 shows an example user interface. The user may add calculator applications and publication objects to cells as previously described, add additional sheets, perform formatting operations, etc. As was previously mentioned, the calculator applications are fully functional and operate as they would operate on the handheld calculator 100. Thus, the user can create document pages in cells with computational dependencies between applications on the same page and on different pages and with a sequential ordering of the pages.

Once the document is created using publication view mode 106, the formatting information for generating the publication view may be stored. As was previously described, in some embodiments, the publication view formatting information and the calculator document pages may be maintained as a single logical metadocument 122. The metadocument 122 may be transmitted to the handheld calculator 100. On the handheld calculator 100, any format rules for the publication view are ignored and the document pages 124 in the metadocument 122 may be displayed in sequential computational order.

Further, once the metadocument 122 is created, changes to the metadocument 122 may be made on either the handheld calculator 100 or the computer system 102 according to the respective capabilities of the calculator 100 and the calculator emulation software on the computer system 102. The changed metadocument 122 may then be communicated from the system making the change to the other system.

In some embodiments, a single logical metadocument is not created. Instead, the publication view of a calculator document and a calculator document are distinct entities. When a calculator document is formatted into a publication view, the formatted document is saved as a publication file type. If the formatted document is to be communicated to a handheld calculator, the formatted document is converted to a calculator document containing the document pages of the formatted document and is saved as a calculator file type that is understood by the handheld calculator. If changes are made to the document on the calculator, those changes may either be manually made in the formatted document on the computer system or the altered document may be sent to the computer system and reformatted in publication view. Similarly, if changes are made to page content in the formatted document, those changes may either be manually made in the document pages on the calculator or the altered formatted document may again be converted to a calculator document that is communicated to the calculator.

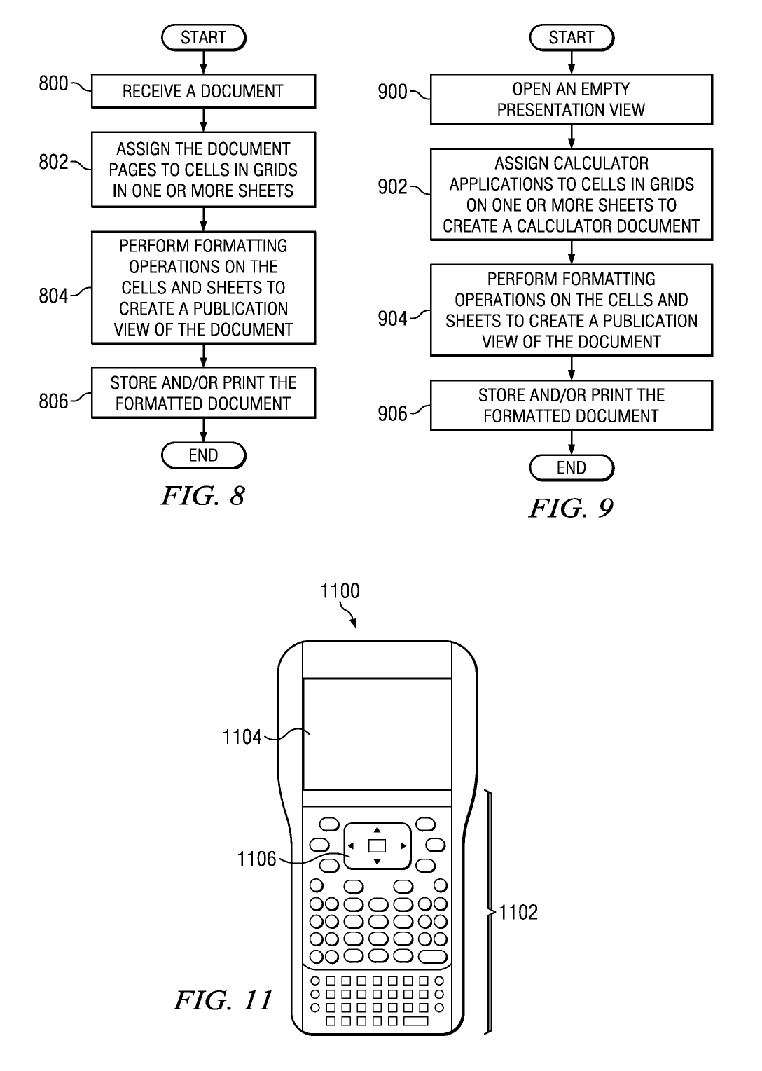

FIG. 8 is a flow diagram of a method for creating a publication view of a calculator document. Initially, a document is received 800 on a computer system and opened in a publication view mode. The document may be created on a handheld calculator or on a computer system using calculator emulation software such as the student and teacher versions of the TI-Nspire™ software. As was previously described, a publication view of a document may be made up of one or more sheets each of which may contain one or more pages of the document. Further, each sheet is logically divided into a grid of cells.

The pages of the document are assigned 802 to cells in grids in one or more sheets. In some embodiments, the pages may be automatically assigned to cells according to a page assignment order as previously described. In some embodiments, a user may use a user interface to manually assign pages to cells.

Formatting operations are performed 804 on the cells and sheets to create the desired publication view of the document. Examples of formatting operations that may be used are previously described herein. The publication view of the document may then be stored and/or printed 806. As was previously described, the document pages and the formatting information to generate the publication view of those pages may be stored. The formatting information may be format rules for each sheet and each cell in a sheet specifying the size, content, location, etc. of each cell and any publication objects layered on a sheet. In some embodiments, the publication view formatting information and the document pages may be maintained in a single logical metadocument as previously described. In some embodiments, the publication view of the document is stored in a file format that cannot be used on a calculator. However, a calculator document in a file format acceptable to a calculator may be generated by converting the publication view file to a calculator document file that contains the document pages from the publication view file.

FIG. 9 is a flow diagram of a method for creating a publication view of a calculator document. Initially, an empty publication view is opened 900. As shown in the example user interface of FIG. 3, the empty publication view may be a single sheet divided into a grid of equal-sized cells. Calculator applications are then assigned 902 to cells in grids on one or more sheets in the publication view to create a calculator document. Any suitable user interface may be used to assign applications to cells. For example, as previously described, the applications may be represented as icons on the user interface and a user may drag and drop an icon into a cell to assign an application to a cell. Assigning an application to a cell logically creates a document page. More than one application may be assigned to a single cell. The applications operate as they would operate on a calculator, so the user may interact with the applications to create a document.

Formatting operations are performed 904 on the cells and sheets to create the desired publication view of the document. Examples of formatting operations that may be used are previously described herein. The publication view of the document may then be stored and/or printed 906. Note that the assignment of application and the formatting need not be performed sequentially. A user may choose to alternate between assigning applications and performing formatting operations. As was previously described, the document pages and the formatting information to generate the publication view of the pages may be stored. The formatting information may be format rules for each sheet and each cell in a sheet specifying the size, content, location, etc. of each cell and any publication objects layered on a sheet. In some embodiments, the publication view formatting information and the document pages may be maintained in a single logical metadocument as previously described. In some embodiments, the publication view of the document is stored in a file format that cannot be used on a calculator. However, a document in a file format acceptable to a calculator may be generated by converting the publication view file to a calculator document file that contains the document pages from the publication view file.

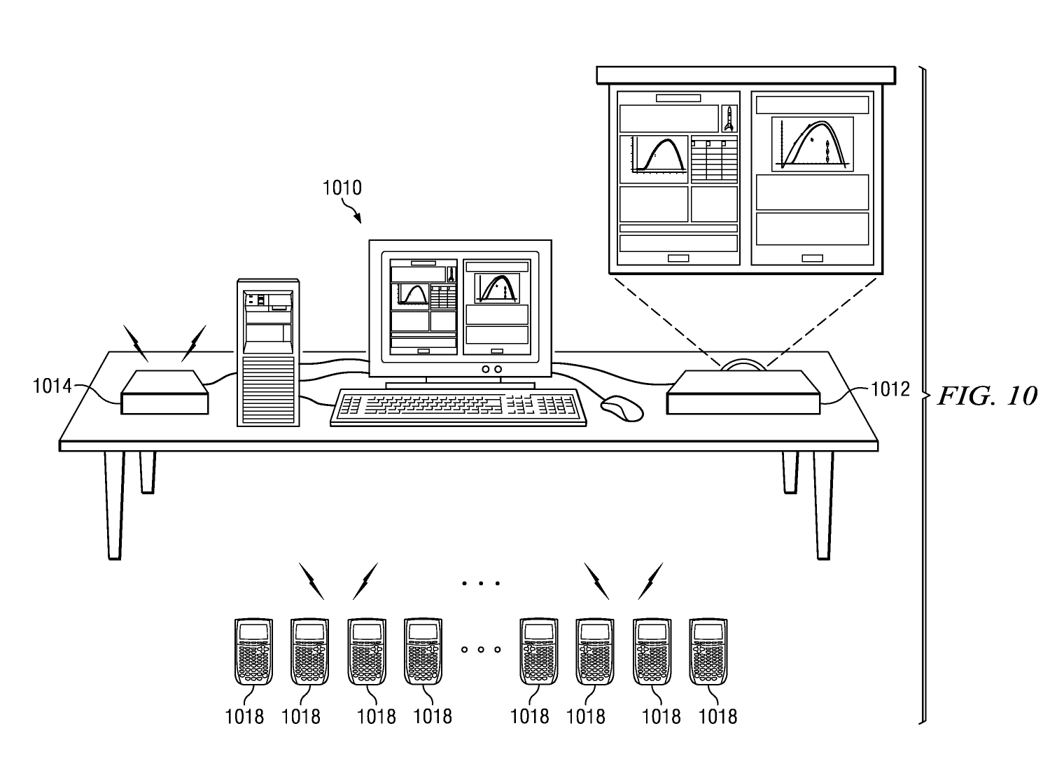

FIG. 10 shows a diagram of a classroom instruction system that may be configured to perform embodiments of the invention. As shown in FIG. 10, the classroom instruction system includes a computer system 1010 communicatively coupled to a projector 1012 (e.g., a digital projector), which may project images and video provided by the computer system 1010 onto a wall, screen, or other surface. The computer system 1010 includes presentation software (not shown) for managing the presentation of screen content received from a handheld calculator as the handheld calculator is operated. The presentation may be made using a display device in the computer system 1010, or using a combination of the display device and the projector 1012. The computer system 1010 may be any general purpose computing device, such as a desktop computer, a mini-computer, a main frame, a laptop computer, a netbook, a tablet computer, or the like.

The computer system 1010 is also communicatively coupled to an access point 1014 via a Universal Serial Bus (USB) connection. The access point 1014 provides a wireless interface such as 802.11b, 802.11g, or the like for the computer system 1010 to communicate with one or more handheld calculators 1018. Once connected, bi-directional communications may be performed between the handheld calculators 1018 and the computer system 1010 via the access point 1014. The computer system 1010 and the access point 1014 are illustrated as separate components for illustrative purposes only. In some embodiments, the access point 1014 may be integrated into the computer system 1010. Further, the coupling between the access point 1014 and the computer system 1010 may be any suitable wired or wireless connection. The combination of the computer system 1010 and the access point 1014 are the network host for the classroom network.

The handheld calculators 1018 may be any suitable handheld calculators, such as, for example, graphing calculators in the TI-Nspire product line available from Texas Instruments, Inc. To allow wireless communication with the access point 1014 and/or the computer system 1010, a wireless transceiver may be integrated into a handheld calculator 1018 or a wireless adaptor or a wireless cradle may be externally attached via a port on a handheld calculator 1018.

Calculator emulation software may be executed on the computer system 1010 that includes functionality as described herein to generate a publication view of document. A teacher may use this software to generate a publication view of a document. The document may have been previously generated on a handheld calculator or using calculator emulation software, or the document may be generated as part of creating the publication view. For example, a teacher may generate a document for a lesson and then generate a publication view of the document. The document may be distributed to the handheld calculators 1018. To conduct the lesson, the teacher may show the publication view of the document using the projector 1012 and the students may interact with the document pages on the handheld calculators 1018 as the teacher conducts the lesson. A teacher may also use the software to generate exams or quizzes.

FIG. 11 shows an example of a handheld calculator 1100 (e.g., 100 of FIGS. 1A-1C and 1018 of FIG. 10). For illustrative purposes, the handheld calculator illustrated in FIG. 11 is similar to graphing calculators available from Texas Instruments Inc. Handheld calculators with more or fewer components may be used in embodiments of the invention. As shown in FIG. 11, the handheld calculator 1100 includes a graphical display 1104, and a keypad 1102 that includes a touchpad 1106. The graphical display 1104 may be used to display, among other things, information input to applications executing on the handheld calculator 1100 and various outputs of the applications. The graphical display 1104 may be, for example, an LCD display. The keypad 1102 allows a user, e.g., a student or instructor, to enter data and functions and to start and interact with applications executing on the handheld calculator 1100. The keypad 1102 also includes an alphabetic keyboard for entering text. The touchpad 1106 allows a user to interact with the display 1104 by translating the motion and position of the user's fingers on the touchpad 1106 to provide functionality similar to using an external pointing device, e.g., a mouse. A user may use the touchpad 1106 to perform operations similar to using a pointing device on a computer system, e.g., scrolling the display 1104 content, pointer positioning, selecting, highlighting, etc.

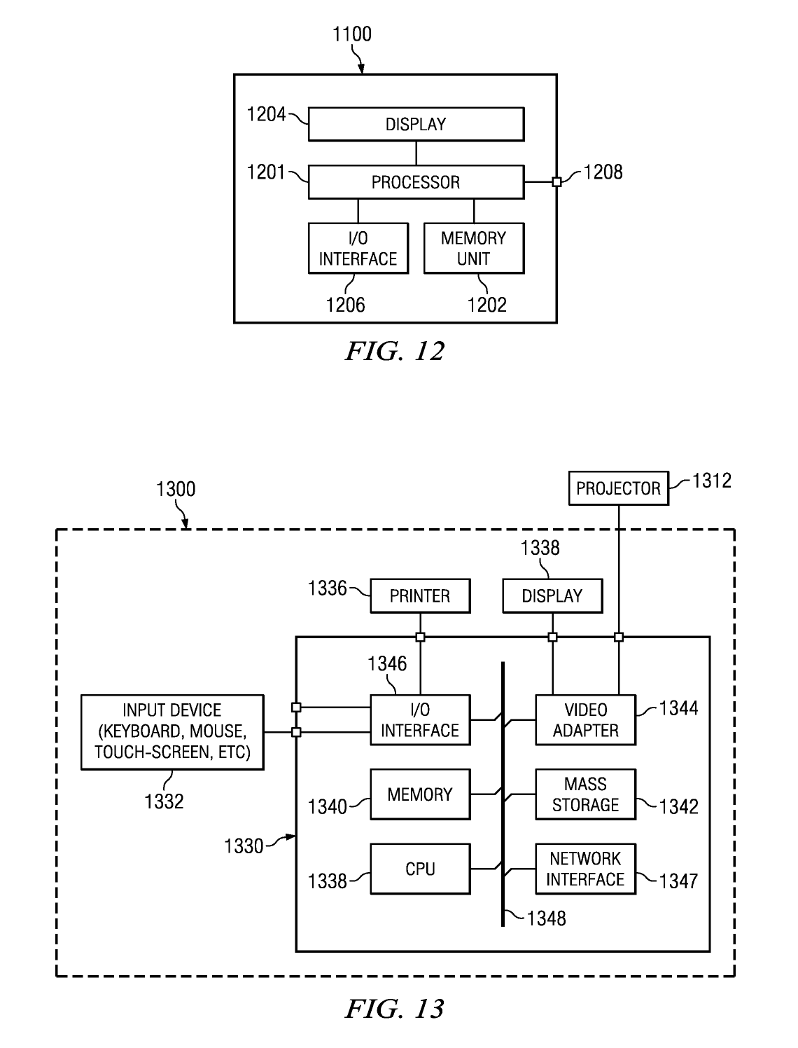

FIG. 12 is a block diagram of the handheld calculator 1100. The handheld calculator 1100 includes a processor 1201 coupled to a memory unit 1202, which may include one or both of read-only memory (ROM) and random-access memory (RAM). In some embodiments, the ROM stores software programs and the RAM stores intermediate data and operating results. An input/output port 1208 provides connectivity to external devices, e.g., a wireless adaptor or wireless cradle. In one or more embodiments, the input/output port 1208 is a bi-directional connection such as a mini-A USB port. Also included in the handheld calculator 1100 are a display 1204 and an I/O interface 1206. The I/O interface 1206 provides an interface to couple input devices such as the touchpad 1106 and the keypad 1102 to the processor 1201. In some embodiments, the handheld calculator 1100 may also include an integrated wireless interface (not shown) or a port for connecting an external wireless interface (not shown). In one or more embodiments, the memory unit 1202 stores software instructions to be executed by the processor 1201 to implement some or all of the calculator based operations of methods described herein. For example, if a metadocument including publication view formatting information is received on the calculator, software stored on the calculator may parse the metadocument to identify the document pages to be used on the calculator and may ignore the remainder of the information in the metadocument. Further, if changes are made to the document on the calculator, software stored on the calculator may update the metadocument to reflect the changes.

FIG. 13 is a block diagram of a computer system 1300 (e.g., 102 of FIGS. 1A-1C and 1010 of FIG. 10). The computer system 1300 includes a processing unit 1330 equipped with one or more input devices 1332 (e.g., a mouse, a keyboard, or the like), and one or more output devices, such as a display 1334, a printer 1336, or the like. In some embodiments, the display 1334 may be touch screen, thus allowing the display 1334 to also function as an input device. The processing unit 1330 may be, for example, a desktop computer, a workstation, a laptop computer, a dedicated unit customized for a particular application, or the like. The display may be any suitable visual display unit such as, for example, a computer monitor, an LED, LCD, or plasma display, a television, a high definition television, or a combination thereof.

The processing unit 1330 includes a central processing unit (CPU) 1338, memory 1340, a mass storage device 1342, a video adapter 1344, and an I/O interface 1346 connected to a bus 1348. The bus 1348 may be one or more of any type of several bus architectures including a memory bus or memory controller, a peripheral bus, video bus, or the like. The CPU 1338 may be any type of processor. For example, the CPU 338 may be a processor from Intel Corp., a processor from Advanced Micro Devices, Inc., a Reduced Instruction Set Computer (RISC), an Application-Specific Integrated Circuit (ASIC), or the like. The memory 1340 may be any type of system memory such as static random access memory (SRAM), dynamic random access memory (DRAM), synchronous DRAM (SDRAM), read-only memory (ROM), a combination thereof, or the like. Further, the memory 1340 may include ROM for use at boot-up, and DRAM for data storage for use while executing programs.

The mass storage device 1342 (e.g., a computer readable medium) may include any type of storage device configured to store data, programs, and other information and to make the data, programs, and other information accessible via the bus 1348. In one or more embodiments, the mass storage device 1342 stores software instructions to be executed by the CPU 338 to generate publication views of documents as described herein. The software instructions may be part of calculator emulation software stored on the mass storage device 1342. The mass storage device 1342 may be, for example, one or more of a hard disk drive, a magnetic disk drive, an optical disk drive, or the like. The software instructions may be initially stored in a computer-readable medium such as a compact disc (CD), a diskette, a tape, a file, memory, or any other computer readable storage device and loaded and executed by the CPU 1338. In some cases, the software may also be sold in a computer program product, which includes the computer-readable medium and packaging materials for the computer-readable medium. In some cases, the software may be distributed to the computer system 1300 via removable computer readable media (e.g., floppy disk, optical disk, flash memory, USB key), via a transmission path from computer readable media on another computer system (e.g., a server), etc.

The video adapter 1344 and the I/O interface 1346 provide interfaces to couple external input and output devices to the processing unit 1330. As illustrated in FIG. 3B, examples of input and output devices include the display 1334 and a projector 1312 coupled to the video adapter 1344 and the mouse/keyboard 1332 and the printer 1336 coupled to the I/O interface 1346.

The processing unit 1330 also includes a network interface 1347. The network interface 1347 allows the processing unit 1330 to communicate with remote units via a network (not shown). In one or more embodiments, the network interface 1347 allows the computer system 1300 to communicate via a network to one or more handheld calculators. The network interface 1347 may provide an interface for a wired link, such as an Ethernet cable or the like, or a wireless link.

The computer system 1300 may also include other components not specifically shown. For example, the computer system 1300 may include power supplies, cables, a motherboard, removable storage media, cases, and the like.

### Other Embodiments

While the invention has been described with respect to a limited number of embodiments, those skilled in the art, having benefit of this disclosure, will appreciate that other embodiments can be devised which do not depart from the scope of the invention as disclosed herein.

For example, in some embodiments, some publication objects may be viewed on a handheld calculator by converting the content of the objects to an image. For example, a text box publication object or an image publication object may be converted to an image displayable on a handheld calculator when the content of a metadocument is displayed on the calculator or when a publication view is converted to a document.

In another example, in some embodiments, publication views of a document may be formatted for viewing on different display sizes. The format information for each of the display sizes may be stored in the metadocument such that when the metadocument is opened on a computer system with a display of a size for which a publication view has been formatted, the format information for that display size is used to create the appropriate publication view for the display.

In another example, in some embodiments, a publication view of a document may be formatted for publication as a web page in a browser. One technique for performing such formatting is described in the previously referenced TI-Nspire™ Teacher Software Guidebook.

It is therefore contemplated that the appended claims will cover any such modifications of the embodiments as fall within the true scope of the invention.

What is claimed is:

1. A method comprising:
assigning a first page of a document to a first cell of a sheet in a publication view, wherein the sheet is logically divided into a plurality of cells arranged in a grid and wherein the first page comprises at least one application executable on a handheld calculator;
formatting the first cell responsive to user-specified format changes; and
saving the publication view of the document, wherein formatting information for the first cell is saved in association with the document.

2. The method of claim 1, wherein assigning a page comprises automatically assigning the page to a cell according to a page assignment order.

3. The method of claim 1, wherein the document was created on a handheld calculator.

4. The method of claim 1, wherein the document was created on a computer system.

5. The method of claim 1, further comprising:
assigning a second page of the document to a second cell of the sheet, wherein the second page comprises at least one application executable on a handheld calculator;
changing a size of the first cell responsive to a user-specified format change, wherein a size of the second cell is changed in proportion to the change in size of the first cell, and
wherein saving the publication view further comprises saving formatting information for the first cell and formatting information for the second cell in association with the document.

6. The method of claim 1, wherein formatting the first cell further comprises:
clipping the page in the first cell to identify a portion of the page to be displayed in the first cell; and
displaying the portion of the page in the first cell.

7. The method of claim 1, wherein formatting the first cell further comprises hiding the first cell, wherein the first page is not displayed in the publication view.

8. The method of claim 1, further comprising:
assigning a publication object to a second cell of the sheet responsive to user input.

9. The method of claim 1, further comprising:
overlaying a publication object on the sheet responsive to user input.

10. The method of claim 1, further comprising:
moving the first page to a second cell in the sheet responsive to user input; and
formatting the first cell responsive to user-specified format changes.

11. A method comprising:
assigning a first application to a first cell of a sheet in a publication view of an empty document, wherein the sheet is logically divided into a plurality of cells arranged in a grid and wherein the first application is executable on a handheld calculator and wherein a page of the document comprising the first application is created responsive to the assigning;
formatting the first cell responsive to user-specified format changes; and
saving the publication view of the document, wherein formatting information for the first cell is saved in association with the document.

12. The method of claim 11, further comprising:
assigning a second application to a second cell of the sheet, wherein the second application is executable on a handheld calculator and wherein another page of the document comprising the second application is created responsive to the assigning;
changing a size of the first cell responsive to a user-specified format change, wherein a size of the second cell is changed in proportion to the change in size of the first cell, and
wherein saving the publication view further comprises saving formatting information for the first cell and formatting information for the second cell in association with the document.

13. The method of claim 11, wherein formatting the first cell further comprises:
clipping the page in the first cell to identify a portion of the page to be displayed in the first cell; and
displaying the portion of the page in the first cell.

14. The method of claim 11, wherein formatting the first cell further comprises hiding the first cell, wherein the page is not displayed in the publication view.

15. The method of claim 11, further comprising:
assigning a publication object to a second cell of the sheet responsive to user input.

16. The method of claim 11, further comprising:
overlaying a publication object on the sheet responsive to user input.

17. A method comprising:
opening a document in a publication view, wherein pages of the document are automatically assigned to cells in a grid in a sheet according to a page assignment order, wherein each page comprises at least one application executable on a handheld calculator;
formatting at least a subset of the cells responsive to user-specified format changes; and
saving the publication view of the document, wherein formatting information for the subset of cells is saved in association with the document.

18. The method of claim 17, wherein the document was created on one selected from a group consisting of: a handheld calculator and a computer system.

19. The method of claim 17, wherein formatting at least a subset of the cells further comprises:
changing a size of a cell responsive to a user-specified format change, wherein sizes of one or more of the other cells in the subset are changed in proportion to the change in size of the first cell, and
wherein saving the publication view further comprises saving formatting information for the first cell and formatting information of the one or more of the other cells in association with the document.

20. The method of claim 17, wherein formatting the first cell further comprises:
clipping the page in a cell to identify a portion of the page to be displayed in the cell; and
displaying the portion of the page in the cell.
